(19) United States
(12) Patent Application Publication
(10) Pub. No.: US 2026/0103847 A1
(43) Pub. Date: Apr. 16, 2026

(54) THREE-PLY PAPER PRODUCT

(71) Applicant: GPCP IP Holdings LLC, Atlanta, GA (US)

(72) Inventor: Kate Hintz, Atlanta, GA (US)

(73) Assignee: GPCP IP Holdings LLC, Atlanta, GA (US)

(21) Appl. No.: 19/351,517

(22) Filed: Oct. 7, 2025

Related U.S. Application Data
(60) Provisional application No. 63/706,246, filed on Oct. 11, 2024.

(51) Int. Cl. D21H 27/32; B32B 29/00; D21H 27/02

(52) U.S. Cl. CPC D21H 27/32; B32B 29/005; D21H 27/02; B32B 2250/05; B32B 2554/00

(57) ABSTRACT

Three-ply paper absorbent paper products, such as absorbent paper towel products, characterized by one or more properties such as absorbency, strength, bulk, durability, and thickness, as well as methods of making the same.

The present application discloses three-ply absorbent paper products, for example three-ply paper towel products. The three-ply paper products can be characterized by one or more physical properties described herein. The present application further discloses methods of making three-ply paper absorbent paper products, for example three-ply paper towel products.

### BACKGROUND

Consumers' daily lives are filled with a variety of modern products that are produced solely for their comfort and convenience. Absorbent paper goods take a prominent place in the list of the most used modern conveniences. Typical paper products used by consumers daily include, for example, paper towels, toilet tissues, napkins, facial tissues, wipers, and the like. In the current market where high-end absorbent paper products demand premium prices, consumers are very particular about the products for which they will pay a premium price.

Product attributes are imparted to paper products both during production of the cellulosic fibrous base sheets, as well as during converting operations such as laminating that are used to bond the cellulosic fibrous base sheets together into the final product.

Multi-ply products are typically made from two or more webs of nonwoven paper. For the products to perform as expected by the consumer, the webs from which these products are formed generally must exhibit a favorable balance of characteristics for the end-use, such as absorbency, strength, bulk, durability, and thickness. It can be challenging to economically maximize all characteristics to deliver an exceptional customer experience with the products. The balancing of desirable properties becomes even more challenging when a product having three plies is desired.

### SUMMARY OF INVENTION

Disclosed herein are three-ply absorbent paper products, such as three-ply paper towel products, with a superior combination of properties, including beneficial ranges of two or more of absorbency, strength, bulk, durability, and thickness.

Also disclosed herein are methods of making three-ply absorbent paper products comprising individual paper base sheets that, when combined, result in a superior three-ply product. In particular, the individual base sheets may be made to target specific property ranges, resulting in a three-ply product with surprisingly superior properties for two or more of absorbency, strength, bulk, durability, and thickness as set out herein.

The three-ply absorbent paper products disclosed herein may be paper towels, napkins, toilet tissues, facial tissues, wipers, hand towels, placemats, and the like. In some embodiments, the three-ply paper products may be rolled products, such as a paper towel or toilet tissue product. In some embodiments, the three-ply paper products may be folded products, such as napkins, facial tissues, or wipers.

### BRIEF DESCRIPTION OF THE FIGURES

FIG. 1 is a schematic diagram of a through-air drying papermaking machine that may be employed according with some embodiments described herein.

FIG. 2 illustrates a cross-sectional view of a three-ply paper product where the individual plies have been ply bonded in accordance with some embodiments described herein.

FIG. 3 exhibits photographs of the web contacting surfaces of structured fabrics that may be employed in accordance with some embodiments described herein.

FIG. 4 demonstrates the top view of a representative structured fabric in accordance with some embodiments described herein.

FIG. 5A and FIG. 5B show views of a contact surface printing apparatus in accordance with some embodiments described herein.

FIG. 6 illustrates a detailed view of the pressing section of the contact surface printing apparatus shown in FIGS. 5A and 5B that may be employed in accordance with some embodiments described herein.

FIG. 7A through 7D show examples of prints of structured fabrics in accordance with some embodiments described herein.

FIG. 8A through 8E demonstrate the steps of establishing a coordinate system in a print of a structured fabric in accordance with some embodiments described herein.

### DETAILED DISCLOSURE

Product attributes are imparted to paper products during production of the individual cellulosic fibrous base sheets, as well as during converting operations such as embossing and the manner of ply-lamination to bond the cellulosic fibrous base sheets together into the final product.

### Base Sheet Formation

As used herein, the terms “web,” “cellulosic web,” “fibrous web,” “paper web,” “paper sheet,” “paper ply,” and “base sheet” are used interchangeably to refer to a single cellulosic web that is dewatered during the papermaking process as disclosed herein. In some instances, it is referred to as a “web,” “cellulosic web” or “fibrous web” before dewatering, as a “paper web,” “paper sheet,” or “paper ply” after dewatering, and as a “base sheet” after converting, but the terms may be used interchangeably. To form a three-ply product, the individual base sheets may be ply bonded or laminated together, for example by adhesive.

The fibrous webs for use in the products of the present disclosure may be made from any art-recognized fibers. Papermaking fibers used to form the absorbent products of the present disclosure include cellulosic fibers, commonly referred to as wood fibers. Specifically, the base sheet of the disclosure can be produced from hardwood (angiosperms or deciduous trees) or softwood (gymnosperms or coniferous trees) fibers, and any combination thereof. In some embodiments, the papermaking fibers are softwood fibers.

Base sheets may be made by a variety of papermaking methods, for example conventional wet pressing (CWP), through-air drying (TAD), eTAD, ATMOS, NTT, UCTAD, and variations thereof. In some embodiments, the individual base sheets may be made by through-air drying. Through-air drying processes have become the method of choice for new capital investment, particularly for the production of soft, bulky, premium quality towel products. In through-air-drying methods, the nascent web is partially dewatered using vacuum suction. Thereafter, the partially dewatered web may be dried without compression by passing hot air through the web while it is supported by a through-drying fabric.

In some embodiments, the methods disclosed herein comprise TAD creped base sheets, for example those made by methods comprising forming a web on a foraminous support, thermally pre-drying the web, applying the web to a Yankee dryer with a nip defined, in part, by an impression fabric, and creping the product from the Yankee dryer. Examples of such TAD creped base sheets are disclosed in the following patents: U.S. Pat. No. 3,994,771 to Morgan, Jr. et al.; U.S. Pat. No. 4,102,737 to Morton; and U.S. Pat. No. 4,529,480 to Trokhan et al. which are incorporated by reference in their entirety.

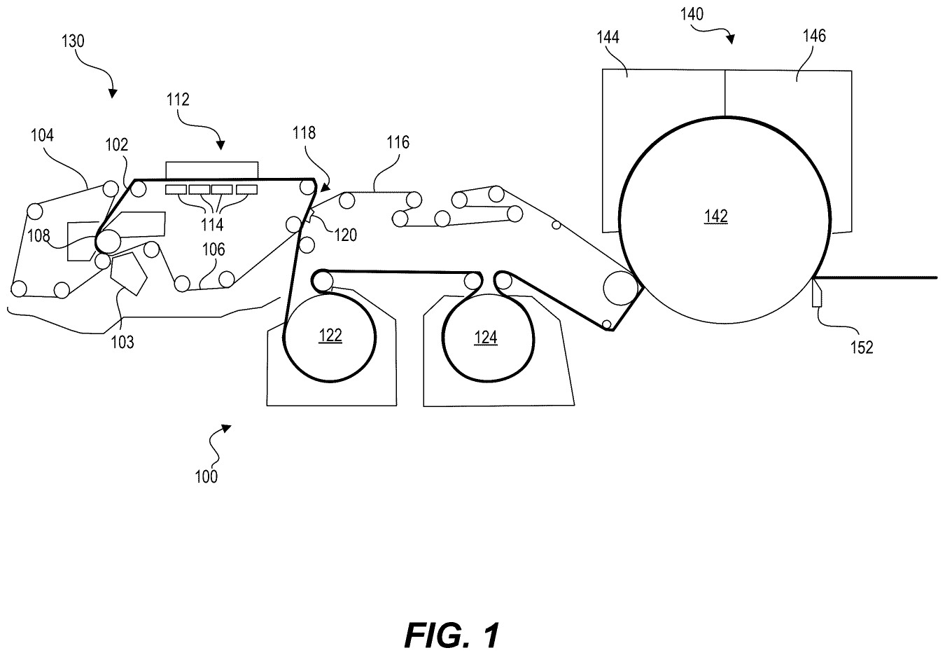

FIG. 1 shows an example of a TAD papermaking machine 100 that may be used in accordance with some embodiments, though any suitable art-recognized TAD papermaking machine may be used, so long as it is capable of forming individual base sheets according to the description herein. The forming section 130 of this exemplary papermaking machine 100 is shown with what is known in the art as a twin-wire forming section, though any suitable art-recognized forming scheme may be employed. For example, an extensive but non-exhaustive list of former designs for use in accordance with the present disclosure includes a crescent former, a C-wrap twin wire former, an S-wrap twin wire former, a suction breast roll former, a fourdrinier former, or any art-recognized forming configuration.

As shown in FIG. 1, the furnish is initially supplied in the papermaking machine 100 through a headbox 103. The furnish is directed by the headbox 103 into a nip formed between a first forming fabric 104 and a second forming fabric 106, ahead of forming roll 108. The first forming fabric 104 and the second forming fabric 106 move in continuous loops and diverge after passing beyond forming roll 108. Vacuum elements such as a vacuum boxes, or foil elements (not shown) can be employed in the divergent zone to both dewater the sheet and to ensure that the sheet stays adhered to second forming fabric 106. After separating from the first forming fabric 104, the second forming fabric 106 and web 102 pass through an additional dewatering zone 112 in which suction boxes 114 remove moisture from the web 102 and second forming fabric 106, thereby increasing the consistency of the web 102 from, for example, about ten percent solids to about twenty-eight percent solids. Hot air may also be used in dewatering zone 112 to improve dewatering. The web 102 is then transferred to a through-air drying (TAD) fabric 116, for example a structured TAD fabric, at transfer nip 118, where a shoe 120 presses the TAD fabric 116 against the second forming fabric 106. In some TAD papermaking machines, the shoe 120 is a vacuum shoe that applies a vacuum to assist in the transfer of the web 102 to the TAD fabric 116. Additionally, so-called rush transfer may be used to transfer the web 102 in transfer nip 118 as well as structure it. Rush transfer occurs when the second forming fabric 106 travels at a speed that is faster than the TAD fabric 116.

The TAD fabric 116 carrying the paper web 102 next passes around through-air dryers 122, 124 where hot air is forced through the web to increase the consistency of the paper web 102, to about seventy to ninety percent solids.

TAD fabrics are known to come in a variety of designs that impart different characteristics to the paper web during the rush-transfer step and set during drying. In some embodiments according to the present description, the TAD fabric is chosen for its ability to impart desirable properties such as one or more of bulk, stretch, and/or a surface texture to the paper web during drying. In some embodiments, the through-drying fabric may be a structured fabric that imparts a three-dimensional structure to the base sheet. In some embodiments, the TAD fabric may be warp and weft yarns woven together.

In FIG. 1, the web 102 is then transferred to the Yankee dryer section 140, where the web 102 is further dried by Yankee drum 142 and corresponding Yankee drum hoods 144, 146. The sheet is then doctored off the Yankee drum 142 by doctor blade 152 and is taken up by a reel (not shown) to form a parent roll (not shown). As a result of the minimal compaction during the drying process, the resulting paper product has a high bulk with corresponding low fiber cost.

In some embodiments, the methods disclosed herein comprise creping the paper sheet from the Yankee dryer with a creping blade to preserve sheet characteristics. Any suitable art-recognized creping blade configurations and/or creping methods may be employed. Creping may occur by affixing the cellulosic web to a Yankee dryer with an adhesive or adhesive/release agent combination and then scraping the web off the Yankee with a creping blade. Any suitable art-recognized creping, Yankee dryers, adhesive agents, release agents, and creping blade methods and/or apparatus may be employed.

In some embodiments, the methods disclosed herein further comprise calendering the paper sheet downstream of the Yankee dryer. Calendering may be used to reduce sheet thickness and/or to improve sheet smoothness. Any suitable art-recognized calendering methods and/or apparatus may be employed. In some embodiments, the web is not calendered after drying.

In some embodiments, the methods disclosed herein further comprise winding the paper sheet onto a reel downstream of the Yankee dryer to await additional operations converting operations. While converting operations are generally carried out on rolled (reeled) paper base sheets, converting operations may also be added directly to the end of a papermaking process or processes without being rolled up first.

While FIG. 1 demonstrates one type of process in which a structuring fabric is used to impart a three-dimensional shape to a paper product, there are numerous alternative papermaking processes in which a structuring fabric is used. For example, a structuring fabric may be used in a papermaking process that does not utilize through air drying (TAD). An example of such a “non-TAD” process is disclosed in U.S. Pat. No. 7,494,563, the disclosure of which is incorporated by reference in its entirety. As will be appreciated by those skilled in the art, the invention disclosed herein is not necessarily limited to any particular papermaking process. In some alternative embodiments, a structured belt in a TAD papermaking process may be used to impart a 3D structure to the paper web instead of a structured TAD fabric.

### Structured Fabric Properties

Structured fabrics for use in forming individual base sheets for the three-ply paper products are described herein based on the following properties. The present inventor has found that three-ply paper products manufactured with structuring fabrics having one or more of the following properties result in three-ply paper products having an improved combination of properties.

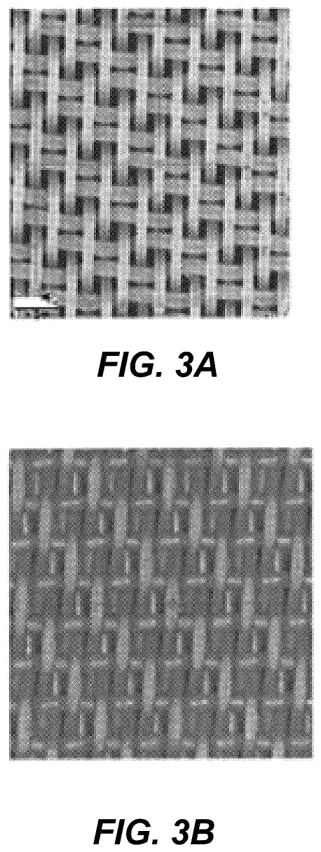

In some embodiments, the structured fabric may be a woven fabric. FIGS. 3A and 3B are magnified photographs of woven structuring fabrics of the type that can be used as the structuring fabric in the papermaking machine shown in FIG. 1. These figures show the surfaces of the fabrics that contact the web in papermaking processes. The warp and weft yarns that make up the body of the structuring fabrics can be seen in FIGS. 3A and 3B.

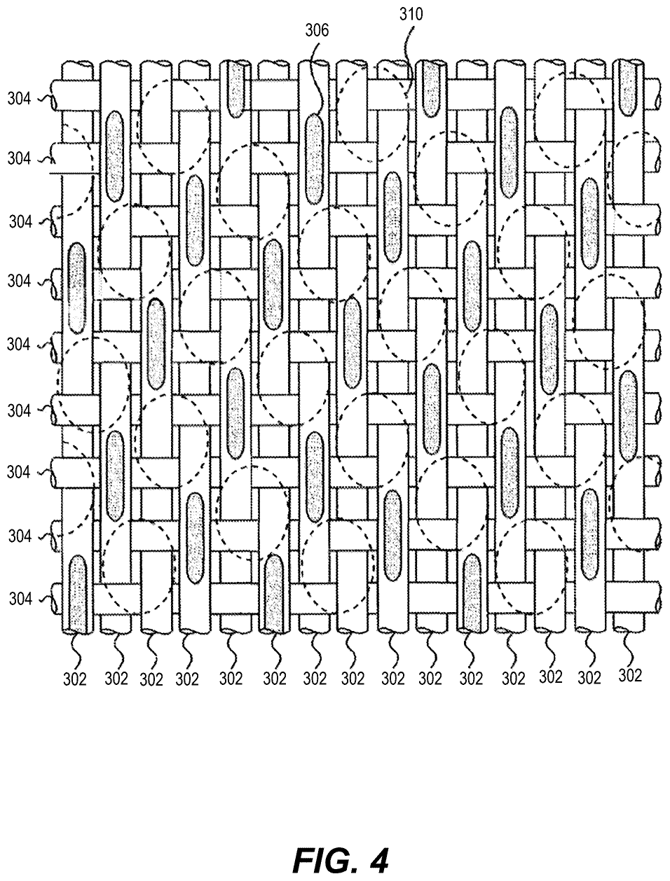

FIG. 4 is a detailed drawing of a portion of the web-contacting side of a structuring fabric having a configuration for forming products according to some embodiments herein. The fabric includes warp yarns 302 that run in the machine direction (MD) when the fabric is used in a papermaking process, and weft yarns 304 that run in the cross machine direction (CD) when the fabric is used in a papermaking process. The warp and weft yarns 302 and 304 are woven together so as to form the body of the fabric. The actual contact surface of the fabric may be formed by the knuckles 306, which are formed on both the warp yarns 202 and the weft yarns 304. That is, the knuckles 206 are in a plane that makes up the contact surface of the fabric. Pockets 310 (shown as the outlined areas in FIG. 4) are defined in the areas between the knuckles 306. During a papermaking operation, portions of the web can be drawn into the pockets 310, and it is the portions of the web that are drawn into the pockets 310 that result in dome structures that are present in the resulting paper product, as described above.

In some embodiments, the warp yarn of the fabric that runs in the MD direction has a width of from about 0.30 mm to about 0.70 mm, for example from about 0.35 mm to about 0.60 mm, or from about 0.35 mm to about 0.45 mm. In some embodiments, the weft yarn of the fabric that runs in the CD direction has a width of from about 0.30 to about 0.80 mm, for example from about 0.40 mm to about 0.70 mm, or from about 0.60 mm to about 0.70 mm. Where the warp or weft yarn has a circular cross-section, “width” refers to the diameter. Where the warp or weft yarn has a non-circular cross-section, such as oval, “width” refers to the widest portion of the cross-section, such as the widest point of the oval.

In some embodiments, the yarn count of the fabric that runs in the MD direction is from about 20 yarns/cm² to about 70 yarns/cm², for example from about 30 yarns/cm² to about 45 to yarns/cm², or from about 35 yarns/cm² to about 42 yards/cm².

In some embodiments, the yarn count of the fabric that runs in the CD direction is from about 20 yarns/cm² to about 70 yarns/cm², for example from about 20 yarns/cm² to about 38 yarns/cm², or from about 24 yarns/cm² to about 30 yarns/cm².

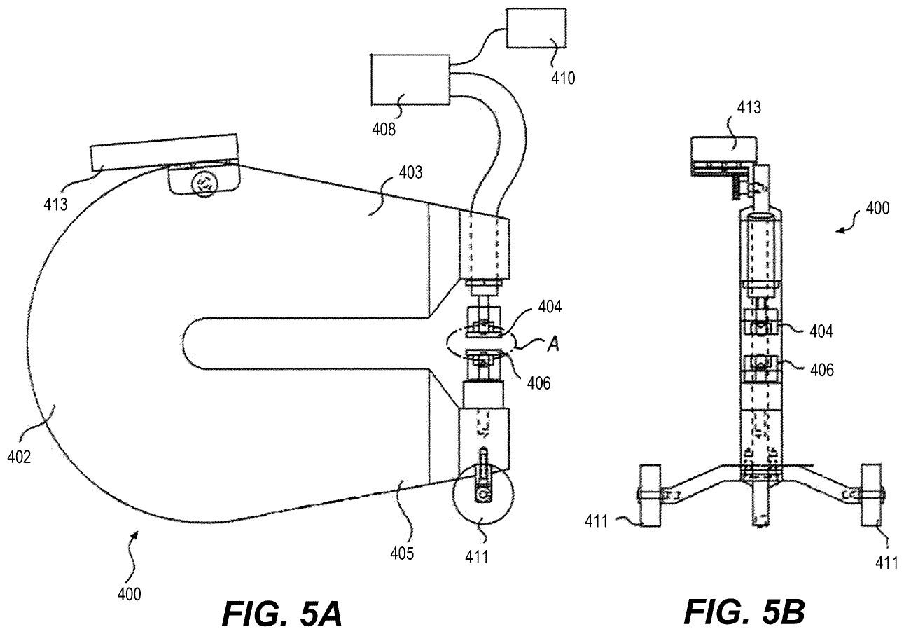

The contact area and pocket density of a structured fabric may be evaluated, for example in accordance with the procedures set forth in U.S. Pat. No. 9,303,363, which is incorporated herein by reference. Those properties can be determined, beginning with forming a representation of the knuckles and pockets of the web contacting side of the structuring fabric. One type of representation is a print of the structuring fabric. In this regard, an apparatus and a technique for forming a print of the contact surface formed by the knuckles of a fabric is shown in FIGS. 5A and 5B. FIG. 5A is a side view of a contact surface printing apparatus 400, and FIG. 5B is a front view of the contact surface printing apparatus 400. This printing apparatus 400 includes a C-shaped frame 402 with first and second arms 403 and 405. A first plate 404 is movably supported by the first arm 403, and a stationary second plate 406 is supported by the second arm 405. A print of the knuckles of a fabric is formed between the first and second plates 404 and 406, as will be described in detail below.

The first plate 404 is operatively connected to a hand-operated hydraulic pump 408 for actuating movement of the first plate 404 towards the second plate 406. The pump 408 has a release valve for allowing the first plate 404 to be retracted from the second plate 406. The pump 408, however, can take many other forms so as to effect movement of the first plate 404. The pump 408 may be connected to a transducer and transducer indicator 410 for measuring the pressure applied by the pump 408 to the first plate 404 as the first plate 404 is pressed against the second plate 406. As a specific example, an ENERPAC® Hydraulic Hand Pump Model CST-18381 by Auctuant Corp. of Milwaukee, Wis., can be used. As a specific example of the pressure transducer, a Transducer Techniques Load Cell Model DSM-SK with a corresponding indicator, made by Transducer Techniques, Inc., of Temecula, 5 Calif., can be used. Of course, in other embodiments, the pump 408, the pressure transducer, and the transducer indicator 410 may be combined into a single unit.

The frame 402 of the contact surface printing apparatus 400 includes wheels 411 adjacent to the front end of the frame 402, as well as a mount 413 that may be used to hold the pump 408 and/or transducer indicator 410. One or more wheels 411 provided to the frame 402 make the frame 402 easier to move. An advantageous feature of the contact surface printing apparatus 400, according to embodiments of the invention, is its portability. For example, with a configuration as shown in FIGS. 5A and 5B, the printing apparatus 400 may be easily moved about sections of a fabric that are mounted on a paper-making machine. As will certainly become appreciated by those skilled in the art, the ability to form prints of the contact surface of a fabric while the fabric is mounted to a papermaking machine, and, thus, to characterize the fabric according to the techniques described below, provides numerous benefits. As one example, the wearing of a fabric on a papermaking machine can easily be monitored by using the contact surface printing apparatus 400 to take prints of the knuckles of the fabric after different periods of operation of the papermaking machine.

While the contact surface printing apparatus 400 shown in FIGS. 5A and 5B includes a frame structure 402 that connects the first and second plates 404 and 406, in other embodiments, a contact surface printing apparatus 400 need not include such a single frame structure 402. Instead, the first and second plates 404 and 406 may be non-connected structures that are individually aligned to form the print of a fabric. In still other embodiments, the plates 404 and 406 may take vastly different forms from those depicted in FIGS. 5A and 5B. For example, one of the plates 404 and 406 could be formed as an extended surface, while the other plate is formed as a circular structure that is rolled across the extended surface. The term “plate,” as used herein, is a broad term that encompasses any structure sufficient for contacting and/or supporting the components for making the print of the fabric. Additionally, as is clear from the description above, the relative motion of the first and second plates 404 and 406 in any embodiment could be reversed, such that the second plate 406 is made movable, while the first plate 404 is held stationary.

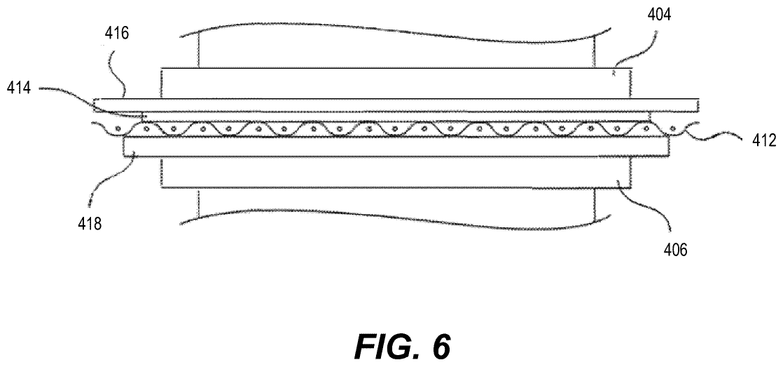

FIG. 6 is a detailed view of Section A of the contact surface printing apparatus 400 shown in FIG. 5A, with the printing apparatus 400 being set up to make a print of a section of a structuring fabric 412. The structuring fabric 412 is positioned between the plates 404 and 406, and a strip of pressure measurement film 414 is positioned against the structuring fabric 412. Between the pressure measurement film 414 and the first plate 404 is one or more sheets of paper 416. Between the structuring fabric 412 and the second plate 406 is a strip of rubber 418.

Pressure measurement film is a material that is structured such that the application of force upon the film causes micro-capsules in the film to rupture, producing an instantaneous and permanent, high-resolution image in the contacted area of the film. An example of such a pressure measurement film is sold as Prescale film by Fujifilm Holdings Corporation of Tokyo, Japan. Another example of pressure measurement film is Pressurex-Micro® by Sensor Products, Inc., of Madison, N.J. Those skilled in the art will recognize that other types of pressure measurement films could be used in the printing techniques described herein. In this regard, it should be noted that for the analysis techniques described below, the pressure measurement film need not provide an indication of the actual pressure applied by the fabric to the film. Instead, the pressure measurement film need only provide a print image showing the contact surface formed by the knuckles of a fabric.

The pressure applied to first plate 404 when forming a print of fabric 412 on pressure measurement film 414 can be selected so as to simulate the pressure that would be applied to a web against the fabric 412 in an actual papermaking process. That is, the pump 408 may be used to generate a pressure (as measured by the transducer) on the first plate 404 that simulates the pressure that would be applied to a web against the fabric 412 in a papermaking process. In the papermaking process described above in conjunction with FIG. 1, the simulated pressure would be the pressure that is applied to the web against the fabric 116 to the Yankee dryer 140. To simulate this papermaking process, six hundred psi of pressure would be applied by the hydraulic pump 408 to the first plate 404 when forming the image of the knuckles of fabric 412 in the pressure measurement film 414. For such an operation, it has been found that medium pressure 10-50 MPa Presclace film by Fujifilm can provide a good image of the knuckles of a structuring fabric.

Referring again to FIG. 6, the paper 416 acts as a cushion to improve the print of the fabric 412 formed on the pressure measurement film 414. That is, the paper 416 provides compressibility and a smooth surface, such that the knuckles of the fabric 412 may “sink” into the pressure measurement film 414, which, in turn, forms a high-resolution image of the knuckles in the pressure measurement film 414. To provide these properties, construction and kraft are examples of types of paper that can be used for the film 414.

The strip of rubber 418 creates a level contact surface for supporting the fabric 412. In embodiments of the invention, the plates 404 and 406 are made of a metallic material, such as steel. A steel plate most likely has imperfections that reduce the quality of the print of the knuckles of the fabric 412 formed in the pressure measurement paper 416. The paper 416 and the rubber 418 that are used between the plates 404 and 406, and the pressure measurement film 414 and the fabric 412, however, provide a more level contact surface than do the surfaces of the metallic plates 404 and 406, thereby resulting in better images being formed in the pressure measurement film 414. Those skilled in the art will recognize that other alternative materials to the paper 416 and rubber 418 may be used as structures to provide the level surfaces between the plates 404 and 406 of the printing apparatus 400.

In other embodiments, a print is made of the knuckles of a fabric in materials other than pressure measurement film. Another example of a material that can be used to form prints of a fabric is wax paper. A print of the contact surface of a fabric may be made in a wax surface by pressing the contact surface of the fabric against the wax paper. The print in the wax paper can be made using the plates 404 and 406 in the print apparatus 400 described above, or with other configurations of the plates. The wax paper print can then be analyzed in the same manner as a pressure measurement film print, as will be described below.

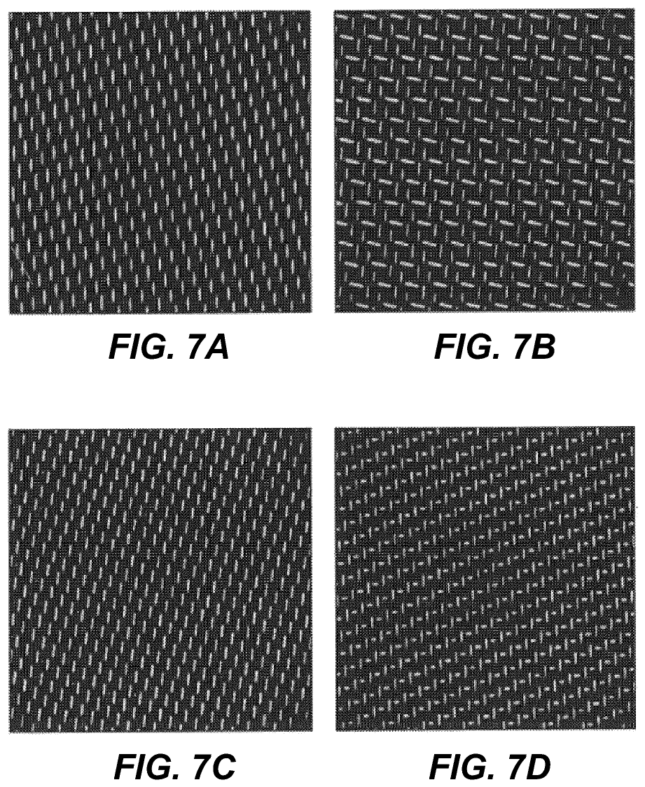

FIGS. 7A through 7D show examples of prints of knuckles formed in pressure measurement film using the contact surface printing apparatus 400. In these prints, the distinctive shapes and patterns of the knuckles of the fabrics can be seen. As discussed above, the knuckles form the contact surface for the fabric. Hence, high resolution prints of the knuckles in a pressure measurement film, such as those shown in FIGS. 7A through 7D, provide an excellent representation of the contact surface of a fabric.

Next, a system for analyzing the prints of knuckles, such as those shown in FIGS. 7A through 7D, will be described. In the system, graphical analysis will be conducted on a conventional computer system. Such a computer system will include well-known components, such as at least one computer processor (e.g., a central processing unit or a multiple processing unit) that is connected to a communication infrastructure (e.g., a communications bus, a crossover bar device, or a network). A further component of the computer system is a display interface (or other output interface) that forwards video graphics, text, etc., for display on a display screen. The computer system may still further include such common components as a keyboard, a mouse device, a main memory, a hard disk drive, a removable-storage drive, a network interface, etc.

As a first step in the analysis, a print of the contact area of the knuckles of a fabric is converted to a computer readable image using a photo scanner. Any type of photoscanner may be used to generate the computer readable image; however, a photoscanner having at least 2400 dots per inch (dpi) has been found to provide a good image for analysis. With the resolution of the scan of the image, an imaging analysis program can apply an exact scale to the image, and the exact scaling will be used in the calculation of the surface characteristics of the structuring fabric (as will be described below).

The scanned image may be stored in a non-transitory computer-readable medium in order to facilitate the analysis described below. A non-transitory computer readable medium, as used herein, comprises all computer-readable media except for a transitory, propagating signal.

The scanned image, as well as characteristics of the contact 40 surface scanned image that are determined according to the techniques described below, may be associated with a database. A “database,” as used herein, means a collection of data organized in such a way that a computer program may quickly select desired pieces of the data that constitute the database. An example is an electronic filing system. In some implementations, the term “database” may be used as shorthand for a “database management system.”

In order to perform quantitative analysis of the scanned print image, an image analysis program is used with the 50 scanned images of the knuckles of a fabric. Such an image analysis program is developed, for example, with computational software that works with graphical images. One example of such computational development software is MATHEMATICA® by Wolfram Research, Inc., of Champaign, III. As will be described below, the image analysis program will be used to specifically identify the knuckles in the fabric print image of the structuring fabric, and, with known scaling of the fabric print image, the image analysis program can calculate the sizes of the knuckles and estimate 60 sizes of the pockets.

When analyzing the scanned image, any size area that includes a plurality of knuckles and a pocket could be used for the analysis described below. In specific embodiments, it has been found that a 1.25 in. by 1.25 in. area of an image of 65 a fabric allows for a good estimation of properties, such as pocket sizes using the techniques described herein. In particular, it has been found that when an image is formed with a 2400 dpi resolution (discussed above) and using a 1.25 in. by 1.25 in. area of image for the analysis, a good characterization of the contact surface can be conducted. Of course, other resolutions and/or area may also provide good results.

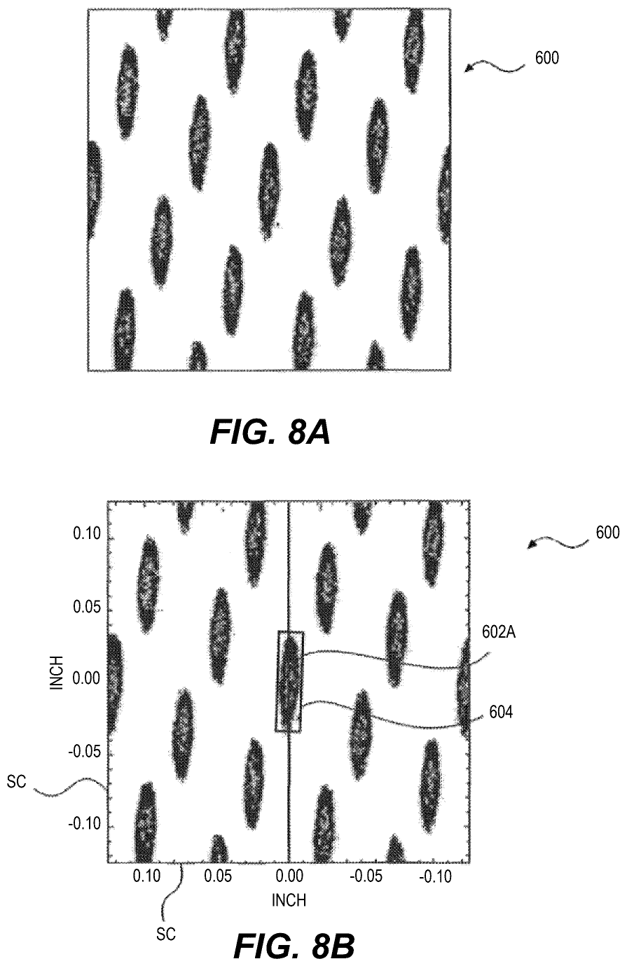

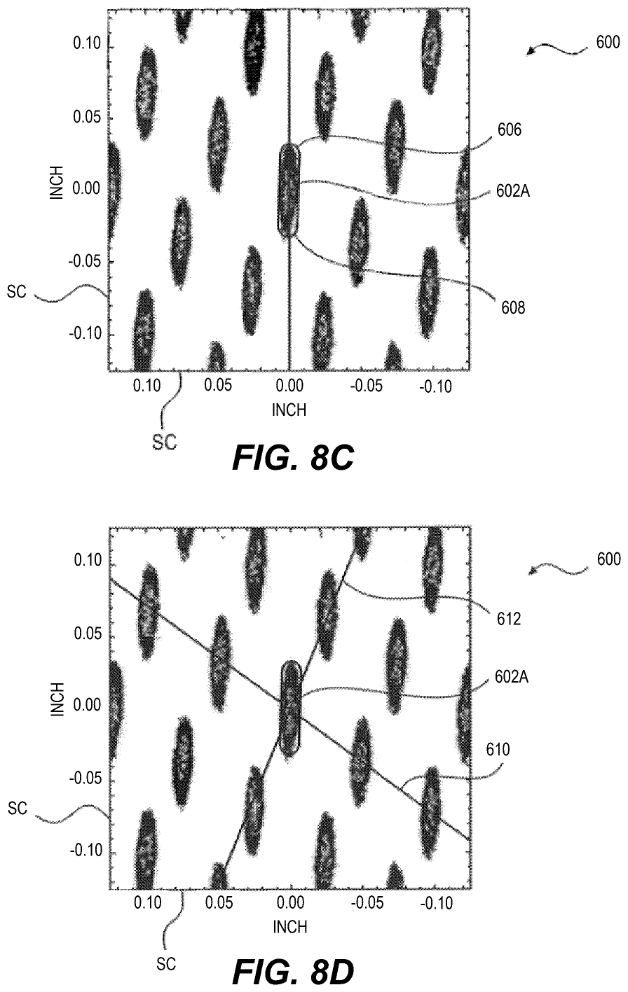

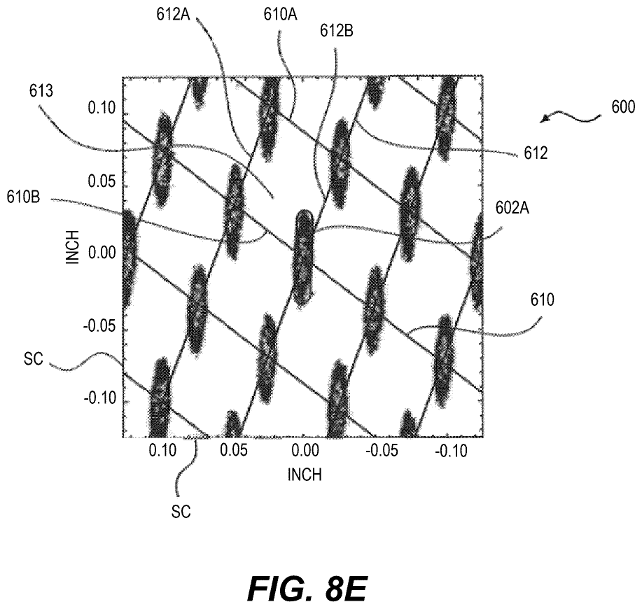

FIGS. 8A through 8E depict the steps of identifying the knuckles in a magnified portion of the scanned image of a print using the image analysis program. Initially, as shown in FIG. 8A, a magnified portion of an image 600 is viewed on the display screen of the computer system running the analysis program. The image 600, which may be formed using the print technique described above, shows the knuckles 602. Along with using the image 600 with the analysis program, the scaling of the image 600 can be input into an analysis program. Such a scaling may be input, for example, as 2400 dpi, from which the analysis program can apply the scale SC to the image 600. The analysis program will then use the scale to calculate the sizes and positions of the knuckles, as described below.

FIGS. 8B and 8C show steps for identifying a specific knuckle 602A using the analysis program. The knuckle 602A is initially selected based on its location at a center region of the magnified image 600. In this step, a rough outline of the knuckle 602A is applied. The rectangular box 604, which may be a stored shape in the analysis program, is initially applied around the knuckle 602A in order to initiate the knuckle identification process. The initial rectangular box 604 shape may then be more closely refined to match the shape of the knuckle 602A, as shown in FIG. 8C. In this case, the ends 606 and 608 are reshaped to be more rounded, and, thus, they more closely correspond to the ends of the knuckle 602A. Although not shown, further refinements could be made to the outline of the knuckle 602A until a sufficient match is made. Such refinements might be conducted by further magnifying the image 600.

As shown in FIG. 8D, after the knuckle 602A is identified by the outline, guidelines 610 and 612 are drawn. The guidelines 610 and 612 are each drawn so as to pass through the center of the knuckle 602A and extend in straight lines through the centers of the other knuckles. Notably, the guidelines 610 and 612 are also drawn to not cross the areas where pockets are formed in the fabric, which are known to correspond to the areas between groups of knuckles. By drawing the guidelines 610 and 612 straight between the centers of the knuckles, the guidelines 610 and 612 do not cross the area of the pockets that are formed between the knuckles.

After the guidelines 610 and 612 are drawn, as shown in FIG. 8E, further guidelines are drawn. These guidelines are drawn in a similar manner to guidelines 610 and 612, i.e., through the centers of the knuckles and not passing through areas where pockets are formed. To aid in the process of drawing the guidelines, a lower magnification may be used. With the guidelines, a coordinate system is, in effect, established for the positions of the knuckles. The analysis program, therefore, can now identify the size and shape of the knuckles based on the outline, and can identify the locations of the knuckles as determined by the points where the guidelines cross. The analysis program further has the scale SC of the image 600 input. It follows that the analysis program can apply the scale to the outline knuckle 602A and the knuckle positioning, to calculate the actual sizes and spacing of the knuckles. Note, as well, that the analysis program may calculate the frequency of the guidelines such as the number of times that the guidelines 612 cross guideline 610 per a unit length. The frequency of each set of guidelines 610 and 612 will be used in calculations of properties of the fabric, and in other aspects of the invention, as will be described below.

It should be noted that, as shown in FIGS. 8D and 8E, the knuckles are all about the same size and all about the same shape, and the knuckles are regularly spaced along the guidelines. This is not surprising, inasmuch as most fabrics for papermaking machines are manufactured with highly consistent yarn patterns, which results in very consistent knuckle sizes and positions. The consistency in size, shape, and placement of the knuckles allows for accurate estimates of the size and shapes of all the knuckles on the contact surface of a fabric based on a single selected knuckle, or on a limited number of identified knuckles, and a close estimate of the sizes and locations of the knuckles can be achieved without identifying each knuckle. Of course, to achieve even further accuracy, more than one knuckle could be identified and the outlines and guidelines could be drawn at different portions of an image.

As shown in FIG. 8E, the guidelines 610 and 612 define a plurality of unit cells. A particular unit cell 613 is shown between guideline segments 610A, 610B, 612A, and 612B. The unit cell 613, in effect, demonstrates the minimum 20 repeating pattern in the fabric, and the maximum allowable pocket size. It should be noted that, while the fabric shown in FIGS. 7A through 7E has about one warp knuckle per unit cell, other fabrics may have more than one warp knuckle and/or more than one weft knuckle per unit cell. The unit cells defined by the knuckle patterns will vary with different fabric patterns.

As will be readily apparent to those skilled in the art, any or all of the steps shown in FIGS. 8A through 8E can either be performed by a user on a display screen, or alternatively, may be automated so as to be performed upon execution of the analysis program. That is, the analysis program may be configured to automatically identify knuckles as the darkened regions of images, outline the knuckles, and then draw the guidelines based on the identified knuckles in the manner described above.

After the selected knuckle has been identified, and after the guidelines established through the knuckles, multiple properties of the fabric may be calculated using knuckle sizes and positions determined by the analysis program. To perform such calculations, the knuckle size and positioning data can be exported from the analysis program to a conventional spreadsheet program to calculate the properties of the fabric. Examples of the determinations made by the analysis program and the calculations that follow from such determinations are shown in Table 1.

TABLE 1

| Characteristic of the Fabric | Determination/Calculation |
|---|---|
| Knuckle Length (KL) | determined based on outline of identified warp |
| | knuckle or identified weft knuckle |
| Knuckle Width (KW) | determined based on outline of identified warp |
| | knuckle or identified weft knuckle |
| Frequency of Guidelines (f) | determined based on guidelines drawn through |
| | knuckles freq 1 = frequency of one set of parallel |
| | lines (per inch or cm) freq 2 = frequency of another |
| | set of parallel lines (per inch or cm) |
| Rounding Radius (r) | determined based on outline of identified warp |
| | knuckle and/or identified weft knuckle, the rounding |
| | radius is the level of rounding that is application |
| | to the corners of rectangular objects |
| Knuckle Density Per Unit Cell | determined based on the number of warp or weft |
| (KDUC) (knuckles per unit cell) | knuckles identified within a cell |
| Unit Cell Knuckle Area (UKA) | warp UKA = warp KW × warp LW − ((2 × warp r)² − |
| | π(warp r)²) weft UKA = weft KW × weft LW − ((2 × |
| | weft r)² − π(weft r)²) |
| Knuckle Density (KD) | F = freq 1 × freq 2 |
| | warp KD = F × warp KDUC |
| | weft KD = F × weft KDUC |
| Total Warp or Weft Knuckle | warp area % = warp KD × warp UKA |
| Contact Area (%) | weft area % = weft KD × warp UKA |
| Contact Area Ratio (Total % | TKCA = warp area % + weft area % |
| In-Plane Knuckle Contact Area) | |
| % Area Contribution (AC) | % warp AC = [warp UKA/(warp UKA + weft UKA)] × |
| | 100% weft AC = [weft UKA/(warp UKA + weft |
| | UKA)] × 100 |
| Pocket Area Estimate (PA) | PA = (1/(freq 1 × freq 2)) − (warp UKA × warp |
| | KDUC) − (weft UKA × weft KDUC) |
| Pocket Density (PD) (pockets | PD = freq 1 × freq 2 |
| per square inch or centimeter) | |

The fabric from which image 600 was obtained only included knuckles 602 on the warp yarns. Other fabrics, however, may include knuckles on the weft yarns such as the fabrics that formed the prints in FIGS. 7B and 7D. With such fabrics, the knuckles on the weft yarns can be identified using the outlining technique described above, and the guidelines can be drawn through the weft knuckles using the technique described above.

In some embodiments, the contact area of the structured fabric described is from about 5% to about 40%, from about 10% to about 35%, or from about 10% to about 18%.

In some embodiments, the knuckle length (also referred to as the in-plane contact length) warp of the structured fabric described is from about 1.3 mm to about 4.2 mm, from about 1.5 mm to about 4.2 mm, or from about 2.5 mm to about 3.0 mm.

In some embodiments, the knuckle length (also referred to as the in-plane contact length) weft of the structured fabric described is from about 0.1 mm to about 2.2 mm, from about 0.4 mm to about 1.0 mm, or from about 0.5 mm to about 0.8 mm.

In some embodiments, the pocket density of the structured fabric described is from about 5 pockets/cm² to about 50 pockets/cm², for example from about 10 pockets/cm² to about 30 pockets/cm², or from about 14 pockets/cm² to about 25 pockets/cm².

Another attribute of structured papermaking fabrics that may be used in accordance with some embodiments, is the pocket depth. As used herein, pocket depth is defined as the measured distance from the surface plane to the deepest part of the pocket in microns. In some embodiments, the pocket depth of the structured fabric described is from about 350 microns to about 1000 microns, for example from about 350 microns to about 800 microns, or from about 350 microns to about 600 microns.

Another attribute of structured papermaking fabrics that may be used in accordance with some embodiments, is the pocket aspect ratio. As used herein, pocket aspect ratio is defined as the ratio of the pocket length to pocket width. Pocket length is defined as the machine-direction length between the web contact plane knuckles, and pocket width is defined as the cross-direction length between the contact plane knuckles. In some embodiments, the pocket aspect ratio of the structured fabric described is from about 0.7 microns to about 2.0 microns, for example from about 1.0 microns to about 2.0 microns, or from about 1.2 microns to about 1.8 microns.

Another attribute of structured papermaking fabrics that may be used in accordance with some embodiments, is the air permeability. As used herein, air permeability is defined as the volumetric flow rate of air through the fabric. Air permeability may be determined by using ASTM D737-Standard Test Method for Air Permeability of Textiles Fabrics. In some embodiments, the air permeability of the structured fabric may be from about 450 cfm to about 850 cfm, for example from about 550 cfm to about 750 cfm, or from about 590 cfm to about 650 cfm.

### Base Sheet Properties

The following paragraphs provide a description of physical properties of individual base sheets disclosed herein prior to ply bonding into a three-ply product according to some embodiments of the present description. The product characteristics as set forth below, and as measured in the Examples, use the following methodologies.

Throughout this specification and claims, it is to be understood that, unless otherwise specified, physical properties are measured after the web has been conditioned according to TAPPI standards and prior to any embossing. If no test method is explicitly set forth for measurement of any quantity mentioned herein, it is to be understood that TAPPI standards should be applied.

Each base sheet may have a basis weight of from about 10 lbs/ream to about 18 lbs/ream, such as from about 11 lbs/ream to about 16 lbs/ream, from about 16 lbs/ream to about 18 lbs/ream, or from about 12 lbs/ream to about 14 lbs/ream. Unless otherwise specified, “basis weight” (BW) refers to the weight of a 3000 square-foot ream (rm) of product (basis weight is also expressed in g/m² or gsm). Likewise, “ream” means a 3000 square-foot ream, unless otherwise specified. Likewise, percent or like terminology refers to weight percent on a dry basis, that is to say, with no free water present, which is equivalent to about 3% to 5% moisture in the fiber.

Each base sheet may have a caliper of from about 110 mils/8 sheet to about 180 mils/8 sheet, for example, from about 130 mils/8 sheet to about 180 mils/8 sheet, from about 150 mils/8 sheet to about 180 mils/8 sheet, or from 140 mils/8 sheet to about 160 mils/8 sheet. Caliper refers to the thickness of a paper sheet and may be determined by physical measurement of the paper sheet with a manual caliper, electronic thickness tester, or other suitable measurement device (mils/8 sheet). Calipers and/or bulk reported herein may be measured at 8 sheet calipers as specified. The sheets are stacked, and the caliper measurement taken about the central portion of the stack. Preferably, the test samples are conditioned in an atmosphere of 23°±1.0° C. (73.4°±1.8° F.) at 50% relative humidity for at least about 2 hours and then measured with a Thwing-Albert Model 89-II-JR or Progage Electronic Thickness Tester with 2-in diameter anvils, 539±10 grams dead weight load, and 0.231 in/sec descent rate. For base sheet testing off of the paper machine reel, single base sheets must be used. Sheets are stacked together aligned in the machine direction. For finished product testing, each sheet of product to be tested must have the same number of base sheets as the product as sold. For testing, eight sheets are selected and stacked together. For napkin testing, napkins are unfolded prior to stacking. For base sheet testing off of winders, each sheet to be tested must have the same number of base sheets as produced off of the winder.

Bulk may also be expressed in units of volume/weight by dividing caliper by basis weight. As used herein, the bulk of a base sheet may be expressed in any acceptable unit, including SI units, for example cm³/g. In some embodiments, each base sheet may have a bulk of at least about 5 cm³/g. In some embodiments, the bulk may be from about 5 cm³/g to about 15 cm³/g, such as from about 6 cm³/g to about 12 cm³/g, or from about 7 cm³/g to about 9 cm³/g.

Dry tensile strengths (MD and CD), stretch, ratios thereof, modulus, break modulus, stress, and strain are measured with a standard Instron test device or other suitable elongation tensile tester, which may be configured in various ways, typically, using 3-inch or 1-inch-wide strips of tissue or towel, conditioned in an atmosphere of 23°±1° C. (73.4°±1° F.) at 50% relative humidity for 2 hours. The tensile test is run at a crosshead speed of 2 in/min. Break modulus is expressed in grams/3 inches/% strain or its SI equivalent of g/mm/% strain. % strain is dimensionless and need not be specified. Unless otherwise indicated, values are break values. GM refers to the square root of the product of the MD and CD values for a particular product.

The wet tensile of the present invention is measured generally following Technical Association of the Pulp and Paper Industry (TAPPI) Method T 576 pm, using a three-inch (76.2 mm) wide strip of tissue that is folded into a loop, clamped in a special fixture termed a Finch Cup, then immersed in water. A suitable Finch cup, 3-in., with base to fit a 3-in. grip, is available from Thwing-Albert. For fresh base sheet and finished product (aged 30 days or less for towel product, aged 24 hours or less for tissue product) containing wet strength additive, the test specimens are placed in a forced air oven heated to 105° C. (221° F.) for five minutes. No oven aging is needed for other samples. The Finch cup is mounted onto a tensile tester equipped with a 2.0-pound load cell with the flange of the Finch cup clamped by the tester's lower jaw and the ends of tissue loop clamped into the upper jaw of the tensile tester. The sample is immersed in water that has been adjusted to a pH of 7.0±0.1 and the tensile is tested after a 5 second immersion time using a crosshead speed of 2 inches/minute. The results are expressed in g/3 in., dividing the readout by two to account for the loop as appropriate.

In some embodiments, the stretch of each base sheet in the CD direction (Stretch CD) is from about 6% to about 15%, such as from about 8% to about 13%, or from about 9% to about 12%.

In some embodiments, the stretch of each base sheet in the MD direction (Stretch MD) is from about 12% to about 30%, such as from about 12% to 25%, or from about 15% to 23%.

In some embodiments, each base sheet has a CD wet tensile strength of from about 350 g/3 inches to about 680 g/3 inches, such as from about 350 g/3 inches to about 550 g/inches, or from about 400 g/3 inches to about 500 g/3 inches.

In some embodiments, each base sheet has a CD dry tensile strength (Tensile CD) of from about 1000 g/3 inches to about 2000 g/3 inches, such as from about 1300 g/3 inches to about 1800 g/3 inches, or from about 1300 g/3 inches to about 1600 g/3 inches.

In some embodiments, each base sheet has a MD dry tensile strength (Tensile MD) of from 1000 g/3 inches to about 2000 g/3 inches, such as from about 1300 g/3 inches to about 2000 g/3 inches, or from about 1300 g/3 inches to about 1800 g/3 inches.

### Three-Ply Product Formation

Converting refers to the process that changes or converts base sheets into final products. Typical converting in the area of paper products according to the present disclosure may include calendaring, embossing, perforating, gluing, plying, slitting, rolling, and/or folding. The paper products disclosed herein may be subjected to any of the recognized converting operations that are readily apparent to the skilled artisan.

Embossing is the act of mechanically working a fibrous ply to cause the fibrous ply to conform under pressure to the depths and contours of a patterned embossing roll. In general, the ply is conveyed through an emboss nip between a pair of emboss rolls that, under pressure, form embossments within the surface of the ply. Unless indicated otherwise, “an emboss, (the noun),” “embossing element,” “embossment,” “boss,” are all used herein interchangeably and refer to an element within an embossing pattern on a pattern roll that causes the base sheet to form protrusions or recessions in the fibrous ply, or to the protrusions or recessions in the base sheets themselves.

In most embossing configurations, at least one of the two roller surfaces directly carriers the emboss pattern to be transferred to the base sheet and may be referred to as a pattern roll. In some configurations, the opposing roll may be known as a backing roll. In some embodiments, the backing roll may have a relatively smooth surface that forms the noticeable impressions on the base sheet. In some embodiments, where two or more base sheets are joined within the embossing nip, the backing roll may be known as a marrying roll.

Pattern rolls may be rigid rolls comprising either a steel body that is directly engraved or a hard rubber coated surface (either directly coated or sleeved) that is laser engraved. While a directly engraved steel roll has a longer lifespan, its production may require significant lead time. Laser engraved sleeved rolls may require less production lead time, but often have a lifespan substantially less than that of a steel roll.

Backing rolls may be resilient rolls comprising a steel core directly coated or sleeved with a resilient material and may or may not be engraved with a pattern. If a pattern is present on the backing roll, the pattern may be either a mated, matched-mated, or a non-mated pattern with respect to the pattern carried on the rigid pattern roll. Backing rolls may also be rigid comprising an uncoated steel body, uncoated hard rubber or resin material, or a core coated with a hard rubber or resin material.

Known embossing configurations include rigid-to-resilient and rigid-to-rigid embossing. In a rigid-to-resilient embossing system, a single or multi-ply substrate is passed through a nip formed between a pattern roll, the substantially rigid surface of which contains the embossing pattern as a multiplicity of protuberances and/or depressions arranged into an aesthetically pleasing manner, and a backing roll, the substantially resilient surface of which may either be smooth or also contain a multiplicity of protuberances and/or depressions that cooperate with the rigid surfaced patterned roll.

In a rigid-to-rigid embossing system, a single-ply or multi-ply substrate is passed through a nip formed between two substantially rigid rolls. The surfaces of both rolls contain the pattern to be embossed as a multiplicity of protuberances and/or depressions arranged into an aesthetically pleasing manner. The protuberance and/or depressions of the two rolls cooperate with each other. Both rolls are generally comprised of either a steel body that is directly engraved or a hard rubber coated surface (either directly coated or sleeved) that is laser engraved.

Embossing patterns of the instant disclosure are made up of elements that may be arranged to create a design. The particular pattern may be chosen based on a myriad of considerations, including those that are functional as well as those that are non-functional aesthetic and ornamental. Emboss patterns for use in the instant disclosure may be or contain an indication of source of the paper product or may be or contain one or more design elements that are trademarks or other source identifiers.

In some embodiments, the methods disclosed herein comprise embossing one or more of the individual base sheets downstream of the Yankee dryer. In some embodiments, one or more of the individual base sheets is not embossed downstream of the Yankee dryer. In some embodiments, one or more base sheets can be embossed, for example only one, two or more, only two, or all three. In some embodiments, one base sheet is embossed and the second and third base sheets are unembossed (or “flat”) base sheets. For example, only the top-ply may be embossed, while the middle and bottom plies remain unembossed flat sheets. In some embodiments, two of the base sheets are embossed and the third is a flat sheet. For example, the top and middle plies may be embossed, while the bottom ply remains an unembossed flat back sheet.

Plying, ply bonding, or laminating is the act of joining two or more base sheets. When the base sheets of the paper product are produced separately, the base sheets are plied together to form the three-ply paper product. Plying may be accomplished by several different techniques, including mechanical ply bonding of the base sheets, emboss ply bonding, and adhesive laminating the base sheets together.

In some embodiments, at least three cellulosic fibrous base sheets are bonded together by at least adhesive lamination, even if other forms of ply bonding may also be used. The adhesive may be any adhesive (e.g., glue) used for adhesive lamination known to one of ordinary skill in the art. In some embodiments, the adhesive may comprise a water-based synthetic resin. In some embodiments, the adhesive may comprise a polyamide-epichlorohydrin (PAE) resin. In some embodiments, the adhesive may comprise a polyvinyl alcohol (PVOH) polymer. In some embodiments, the adhesive may comprise a polyamideamine-epichlorohydrin (PAE) resin and/or water lamination.

In the manufacture of paper products having three base sheets, two (or more) lamination stacks are often used, with two base sheets joined, laminated, and/or embossed in a first lamination stack and a third ply added and joined, laminated, and/or embossed to the first two base sheets in a second lamination stack. Additional base sheets may further by joined, laminated, and/or embossed in additional lamination stacks. Unfortunately, the use of two or more lamination stacks increases not only the financial investment needed to manufacture a product, but also the footprint needed for such equipment in a facility. Moreover, the attributes of the final product, such as strength, stretch, caliper, absorbency, plybond, aesthetics, and scrub resistance are often impacted by the number of lamination stacks used.

In some embodiments, the process of ply bonding three base sheets may be done according to WO2024038337, which utilizes a single lamination stack and is incorporated herein by reference in its entirety. In particular, the methods according to WO2024038337 comprise forming at least three cellulosic fibrous base sheets on a papermaking machine; conveying a first ply and a second ply together through a first nip between an adhesive applicator roll and a second roll (for example an embossing, backing, or marrying roll) at a line speed, the nip having a gap between the two rolls of from about 0.000 inches to 0.0035 inches; transferring an adhesive having a solids content of from about 6% to about 10% from an anilox roll to the adhesive applicator roll, wherein the anilox roll is rotated at a speed from about 50% to about 100% of the line speed; transferring the adhesive from the adhesive applicator roll to a first surface of the second ply at the first nip, whereby some portion of the adhesive remains on the first surface of the second ply and some portion of the adhesive is driven though the width of the second ply to the second surface of the second ply and forms a first adhesive bond between the first ply and the second ply; and conveying the first and second cellulosic fibrous plies and a third cellulosic fiber ply together through a second nip between the second roll and a third roll (for example an embossing, backing, or marrying roll), whereby the third ply is adjacent to the second ply and some portion of the adhesive remaining on the first surface of the second ply forms a second adhesive bond between the second ply and the third ply. In some embodiments, the three-ply lamination may be carried out in accordance with FIG. 1A of WO2024038337. In some embodiments, the three-ply lamination may be carried out in accordance with FIG. 1B of WO2024038337.

The term “nip” between two rolls refers to the location where one or more base sheets pass between two adjacent rolls. As used herein, “line speed” refers to the speed at which fibrous base sheets move through the converting section of the papermaking machine, which may be determined by the speed of the rewinder at the beginning of the converting section where a rewinder is present. Line speed is measured in length per time (for example feet per minute or meters per minute). The term “gap” (or “nip gap”) refers to the narrowest distance between the surfaces of the two rolls in the nip. In embodiments where the second roll includes embossments, the nip gap may be measured as the narrowest distance from the top of the embossment to the surface of the adhesive applicator roll.

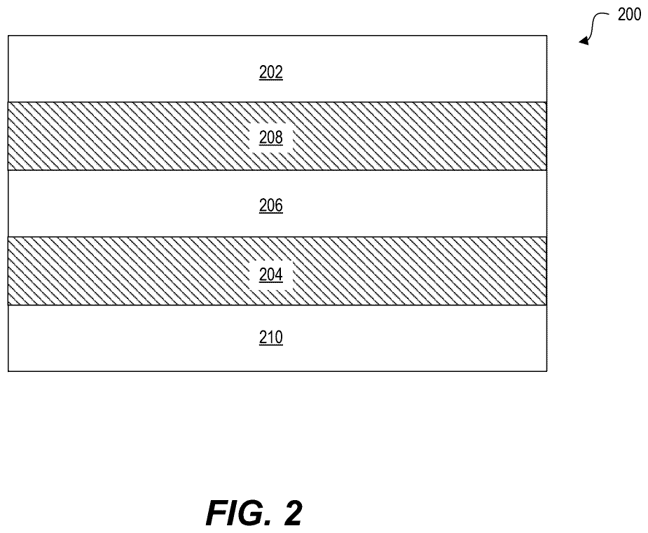

FIG. 2 depicts an exemplary three-ply paper product 200 according to the present disclosure made by the lamination process of WO2024038337, including the first cellulosic fibrous ply 202 adhesively bonded to the second cellulosic fibrous ply 206 by a first adhesive 208 and the third ply 210 adhesively bonded to the second ply 206 by a second adhesive 204.

One of skill in the art would recognize other lamination stack and adhesive configurations that may be used in accordance with the methods herein (either single or double lamination stack configurations).

In some embodiments, neither the first nor second fibrous base sheets may be embossed prior to a first nip. In some embodiments, the first fibrous ply may be embossed prior to the first nip. In some embodiments, the second fibrous ply may be embossed prior to the first nip. In some embodiments, both the first and second fibrous base sheets may be embossed prior to the first nip. In some embodiments, one of the first and second fibrous base sheets may be embossed in a nip between the second roll and a fourth roll prior to the first nip. In some embodiments, both the first and second fibrous base sheets may be embossed together in a nip between the second roll and a fourth roll prior to the first nip.

In some embodiments, the first cellulosic fibrous ply may be adhesive laminated to the second cellulosic fibrous ply in a flat-to-flat configuration, in a tip-to-flat configuration, or a tip-to-tip configuration, depending on whether none, one, or both base sheets are embossed.

In some embodiments, neither the second nor third fibrous base sheets may be embossed prior to a second nip. In some embodiments, the second fibrous ply may be embossed prior to the second nip. In some embodiments, the third fibrous ply may be embossed prior to the second nip. In some embodiments, both the second and third fibrous base sheets may be embossed prior to the second nip.

In some embodiments, the first, second, and third base sheets may be embossed together in the second nip between the third roll and a fifth roll.

In some embodiments, the second cellulosic fibrous ply may be adhesive laminated to the third cellulosic fibrous ply in a flat-to-flat configuration, in a tip-to-flat configuration, or a tip-to-tip configuration, depending on whether none, one, or both base sheets are embossed.

### Three-Ply Product Properties

The following paragraphs provide a description of physical properties of three-ply products according to some embodiments of the present description.

In some embodiments, the three-ply paper product is an absorbent product. In some embodiments, the three-ply paper product is suitable for use in personal hygiene, domestic or commercial cleaning, or in other consumer applications. In some embodiments, the three-ply paper products may be rolled products, such as a paper towel or toilet tissue product. In some embodiments, the three-ply paper products may be folded products, such as a napkins, facial tissues, or wipers. In some embodiments, the three-ply product is a paper towel product.

The basis weight of the three-ply product may vary depending on the intended use. In some embodiments, for example a three-ply paper towel product, the three-ply paper product may have a basis weight of from about 30 lb/rm to 54 lb/rm, such as from about 33 lb/rm to about 48 lb/rm, from about 48 lb/rm to about 54 lb/rm, or from about 36 lb/rm to about 42 lb/rm.

In some embodiments, the three-ply paper product exhibits a caliper of from about 300 mils/8 sheets to about 450 mils/8 sheets, such as from about 300 mils/8 sheets to about 400 mils/8 sheets, from about 350 mils/8 sheets to about 450 mils/8 sheets, or from about 320 mils/8 sheets to about 380 mils/8 sheets. For finished three-ply product testing, each sheet of product to be tested must have the same number of base sheets as the product as sold. For testing in general, eight sheets are selected and stacked together. For rolled or folded product testing, the product should be unwound or unfolded prior to stacking.

In some embodiments, the three-ply paper product may exhibit a bulk of at least about 15 cm³/g. In some embodiments, the bulk may be from about 15 cm³/g to about 45 cm³/g, such as from about 16 cm³/g to about 35 cm³/g, from about 17 cm³/g to about 30 cm³/g, or from about 20 cm³/g to about 25 cm³/g.

Properties of the three-ply product, such as dry or wet tensile strengths (MD and CD), stretch (MD and CD), ratios thereof, modulus, break modulus, stress, and strain may be measured as set forth above with respect to the individual base sheets.

In some embodiments, the stretch of the three-ply paper product in the CD direction (Stretch CD) is from about 6% to about 14%, such as from about 8% to about 12%, or from about 9% to about 12%.

In some embodiments, the stretch of the three-ply paper product in the MD direction (Stretch MD) is from about 12% to about 30%, such as from about 12% to 25%, or from about 15% to 23%.

In some embodiments, the three-ply paper product has a CD dry tensile strength (Tensile CD) of from about 3000 g/3 inches to about 7000 g/3 inches, such as from about 4000 g/3 inches to about 6000 g/3 inches, or from about 4500 g/3 inches to about 5500 g/3 inches.

In some embodiments, the three-ply paper product has a MD dry tensile strength (Tensile MD) of from 3000 g/3 inches to about 8000 g/3 inches, such as from about 4000 g/3 inches to about 6000 g/3 inches, or from about 5000 g/3 inches to about 6000 g/3 inches.

In some embodiments, the three-ply paper product has a CD finch wet tensile strength (Wet Tensile CD) of from about 1200 g/3 inches to about 2000 g/3 inches, such as from about 1200 g/3 inches to about 1500 g/3 inches, or from about 1500 g/3 inches to about 2000/3 inches.

Dry TEA is measured during the procedure to measure dry tensile and is calculated by determining the area under the load/elongation (stress/strain) curve divided by the product of the gauge length and specimen width. Both the gauge length and specimen width are 3 in. TEA is referenced in TAPPI test method T581. Dry TEA is a measure of strength and is reported CD TEA, MD TEA, or GM TEA. The area is based on the strain value reached when the sheet is strained to rupture, and the load placed on the sheet has dropped to 65 percent of the peak tensile load. Since the thickness of a paper sheet is generally unknown and varies during the test, it is common practice to ignore the cross-sectional area of the sheet and report the “stress” on the sheet as a load per unit, or typically 5 in the units of grams per 3 inches of width.

Wet TEA is measured during the procedure to measure Wet Tensile and is calculated by determining the area under the stress/strain curve divided by the product of the gauge length and specimen width. Specimen width is 3 in. Gauge length for wet tensile is 2 in.×1.75 in. as the sample is folded into a loop. Wet TEA is related to the perceived durability of a product. Wet Tensile and Wet TEA are most often referenced in the weaker or lower direction (MD or CD) as this is believed to be how the product will fail in-use. In the case of this product, CD is most often referenced as the weaker or lower tensile direction. For the TEA calculation, the stress is converted to grams per millimeter and the area calculated by integration. The units of strain are millimeters per millimeter so that the final TEA units become mm-gm/mm² or simply gm/mm. Alternatively, the units may be expressed in ft-lb/ft² or simply lb/ft. In some embodiments, CD Wet TEA refers to the use of a machine to measure the amount of force required to break through a wet paper towel.

In some embodiments, the three-ply paper product has a CD wet tensile energy absorption (Wet TEA CD) of from about 0.65 ft-lb/ft² to about 1.5 ft-lb/ft², such as from about 0.75 ft-lb/ft² to about 1.3 ft-lb/ft², or from about 0.85 ft-lb/ft² to about 1.2 ft-lb/ft².

The Gardner Scrub Test measures the scrub resistance of a paper towel and is measured based on the number of back-and-forth rubs required for the paper towel to fail. A paper towel is cut in 7 in. (CD direction)×6.0 in.-6.5 in. (MD direction) and sprayed with 10 pumps of distilled water (˜1.5 g per pump). The wetted paper towel is secured onto a foam block which measures 3 in.×2¾ in with the CD direction of the paper towel in the long direction of the foam. The foam block is placed into the sled of the BYK Gardner Scrub Abrasion Tester, and the instrument is run for 1 cycle which is 2 back and forth rubs. Upon completion of the cycle the paper towel is examined. If there is a tear/hole that is ½″ or larger through all plies or if there is an accumulation of tears/holes that add up to ½″ or greater through all plies, it is a failure. Once the towel fails, the cumulative number of runs (including the run in which the towel failed) is multiplied by 2. This represents the number of back and forth rubs it took to fail, or “scrubs until fail.”

In some embodiments, the three-ply paper product has a scrub until fail of from about 24 rubs to about 38 rubs, such as from about 24 rubs to about 36 rubs, from about 28 rubs to about 38 rubs, or from about 24 rubs to about 32 rubs.

In some embodiments, the strength of the ply bond for the three-ply paper product is measured with a ply bond test. This method determines the average load required to separate the plies. For towel testing, three sheets from a roll are cut at the perforations. The three sheets are then stacked on top of each other maintaining the same orientation and then a 3-in. wide by maximum length strip is cut through the center of the stack with the long dimension in the machine direction. Each specimen is then cut into a 4.5-in. strip. The plies are then separated at the leading edge for a towel and the end closest to the fold for a napkin in approximately ½-in all the way across the 3-in. dimension. The bottom and top ply is then individually folded into 0.5-in. and inserted into the clamp 3-in. edge parallel to the line contact of grip and placed onto the load cell. The test samples are then measured with a Thwing-Albert Model 2260 Friction/Peel Tester. The ply bond of the top-middle (T-M) and the middle-bottom (M-B) are measured in g/width. Overall (total) ply bond is the sum of the T-M and M-B ply bonds. As used herein, the term top refers to the outer ply of the three-ply product that generally faces the consumer. For example, for a rolled absorbent paper product, such as a paper towel product, the top ply is the ply that faces the outside of the roll. As used herein, the bottom ply is the ply that generally faces away from the consumer. For example, for a rolled absorbent paper product, such as a paper towel product, the bottom ply is the ply that faces the inside of the roll.

In some embodiments, the T-M ply bond of the three-ply paper product is about 5 g/width to about 50 g/width, from about 10 g/width to about 40 g/width, or from about 10 g/width to about 25 g/width.

In some embodiments, the M-B ply bond of the three-ply paper product is about 20 g/width to about 120 g/width, from about 30 g/width to about 100 g/width, or from about 30 g/width to about 60 g/width.

In some embodiments, the total ply bond of the three-ply paper product is from about 25 g/width to about 170 g/width, from about 40 g/width to about 140 g/width, or from about 40 g/width to about 85 g/width.

In some embodiments, absorbency of the inventive products (SAT) is measured with a simple absorbency tester. The simple absorbency tester is a particularly useful apparatus for measuring the hydrophilicity and absorbency properties of a sample of tissue, napkins, or towel. In this test a sample of tissue, napkins, or towel 2.0 in. (5.08 cm) in diameter is mounted between a top flat plastic cover and a bottom grooved sample plate. The tissue, napkin, or towel sample disc is held in place by a ⅛ in. (0.32 cm) wide circumference flange area. The sample is not compressed by the holder. Deionized water at 73° F. (22.8° C.) is introduced to the sample at the center of the bottom sample plate through a 3 mm. diameter conduit. This water is at a hydrostatic head of minus 5 mm. Flow is initiated by a pulse introduced at the start of the measurement by the instrument mechanism. Water is thus imbibed by the tissue, napkin, or towel sample from this central entrance point radially outward by capillary action. When the rate of water imbibition decreases below 0.005 gm water per 5 seconds, the test is terminated. The amount of water removed from the reservoir and absorbed by the sample is weighed and reported as grams of water per square meter of sample or grams of water per gram of sheet.

In practice, an M/KSystems Inc. Gravimetric Absorbency Testing System is used. This is a commercial system obtainable from M/K Systems Inc., 12 Garden Street, Danvers, Mass. 01923. WAC, or water absorbent capacity, also referred to as SAT capacity, is actually determined by the instrument itself. SAT capacity is defined as the point where the weight versus time graph has a “zero” slope, i.e., the sample has stopped absorbing. The termination criteria for a test are expressed in maximum change in water weight absorbed over a fixed time period. This is basically an estimate of Zero slope on the weight versus time graph. The program uses a change of 0.005 g over a 5 second time interval as termination criteria; unless “Slow SAT” is specified in which case the cut off criteria is 1 mg in 20 seconds. SAT rate is measured during the procedure to measure SAT Capacity. The SAT rate is the best fit slope between 10 and 60 percent of the end point (grams of water absorbed).

In some embodiments, the three-ply paper product has a SAT capacity (g/m²). SAT capacity is measure of a paper sheet's ability to absorb water. In some embodiments, the three-ply paper product exhibits a SAT capacity of from about 800 to about 1300 g/m², such as from about 850 to about 1100 g/m², from about 1100 to about 1300 gm², or from about 900 to about 1000 g/m².

In some embodiments, the three-ply paper product has a SAT rate (g/s^{0.5}) of from about 0.4 g/s^{0.5} to about 0.8 g/s^{0.5}, such as from about 0.50 g/s^{0.5} to about 0.70 g/s^{0.5}, from about 0.50 g/s^{0.5} to about 0.60 g/s^{0.5}.

A number of embodiments have been described and a number of examples are shown below. Nevertheless, it will be understood that various modifications may be made without departing from the spirit and scope of the disclosure, nor are the inventive aspects limited to the examples disclosed. Accordingly, other embodiments are within the scope of the following claims.

### EXAMPLES

### Example 1

Table 2 shows the properties of exemplary TAD structured fabrics for use in forming the individual base sheets in accordance with some embodiments of the present disclosure, including pocket depth, contact area, pocket density, and pocket length and width.

TABLE 2

| Property | Unit | F1 | F2 | F3 | F4 | F5 | F6 |
|---|---|---|---|---|---|---|---|
| Warp | mm | 0.35 | 0.4 | 0.45 | 0.4 | 0.39 | 0.45 |
| Weft | mm | 0.6 | 0.7 | 0.7 | 0.7 | 0.5 | 0.50 |
| Total Contact | % | 17.8 | 10.7 | 13.8 | 15.8 | 13.6 | 11.6 |
| Area | | | | | | | |
| MD Yarn Count | Count | 44 | 37 | 34 | 38 | 39 | 41 |
| CD Yarn Count | Count | 26 | 24 | 22 | 24 | 34 | 36 |
| Pocket Density | /cm2 | 19.0 | 14.4 | 12.3 | 14.3 | 21.6 | 14.9 |
| Air | cfm | 656 | 601 | 660 | 720 | 600 | 572 |
| Permeability | | | | | | | |
| In-Plane | mm | 2.75 | 2.87 | 3.0 | 4.0 | 1.7 | 1.46 |
| Contact Length | | | | | | | |
| Warp | | | | | | | |
| In-Plane | mm | 0.54 | 0.61 | 0.68 | 0.54 | 0.48 | 2.0 |
| Contact Length | | | | | | | |
| Shute | | | | | | | |
| Pocket Aspect | — | 1.8 | 1.8 | 1.6 | 1.8 | 1.4 | 0.8 |
| Ratio | | | | | | | |
| Pocket Depth | microns | 394 | 530 | 601 | 617 | 536 | 655 |

### Example 2

Table 3 shows the properties of exemplary individual base sheets that make up the three-ply products in accordance with some embodiments of the present disclosure prior to lamination. Some of the individual base sheets in Table 3 were made using structured fabrics similar to those described in Table 2. For example, fabric F2 was used to create the base sheet B1 shown in Table 3 below.

TABLE 3

| Property | Unit | B1 | B2 | B3 | B4 | B5 | B6 |
|---|---|---|---|---|---|---|---|
| Basis Weight | lb/rm | 13.2 | 13.1 | 15.1 | 12.9 | 12.1 | 16.1 |
| Caliper | mils/8 | 146.6 | 144.3 | 168.1 | 138.0 | 133.2 | 147.2 |
| | sheet | | | | | | |
| MD Stretch | % | 19.3 | 15.4 | 23.00 | 18.1 | 19.3 | 22.5 |
| CD Stretch | % | 10.8 | 14.8 | 12.1 | 11.5 | 12.6 | 11.4 |
| CD Wet | g/3 in | 476 | 467 | 651 | 470 | 414.6 | 440 |
| Tensile | | | | | | | |
| CD Dry | g/3 in | 1405 | 1407 | 1768 | 1585 | 1439 | 1511 |
| Tensile | | | | | | | |
| MD Dry | g/3 in | 1495 | 1492 | 1937 | 1671 | 1612 | 1609 |
| Tensile | | | | | | | |

### Example 3

Table 4 shows the properties of exemplary three-ply paper products in accordance with some embodiments of the present disclosure that exhibit a beneficial balance of characteristics for consumer end-use. Some three-ply paper products were created using particular base sheets. For example, a base sheet similar to B4 was used to create the three-ply paper product P6 shown in Table 4. Both three-ply paper products, P4 and P5, were created using fabric, F4 (Table 2). Table 5 shows comparative one- or two-ply products not made in accordance with the present disclosure.

TABLE 4

| | | Inventive Set | | | | | |
|---|---|---|---|---|---|---|---|
| Property | Unit | P1 | P2 | P3 | P4 | P5 | P6 |
| Basis Weight | lb/rm | 39.3 | 39.1 | 45.4 | 38.7 | 38.6 | 38.99 |
| Caliper | mils/8 sheet | 329 | 335 | 381 | 340 | 336.98 | 338.23 |
| MD Stretch | % | 14.8 | 20.3 | 21.6 | 14.6 | 19% | 17% |
| CD Stretch | % | 10.5 | 11.0 | 11.9 | 12.4 | 11% | 11% |
| CD Wet | g/3 in | 1398 | 1362 | 1675 | 1260 | 1387 | 1390 |
| Tensile | | | | | | | |
| CD Wet TEA | mm-gm/mm² | 1.31 | 1.40 | 1.79 | 1.19 | 1.433 | 1.171 |
| CD Dry | g/3 in | 4778 | 4500 | 5460 | 4299 | 4826 | 4788 |
| Tensile | | | | | | | |
| MD Dry | g/3 in | 5169 | 4911 | 5811 | 4863 | 5349 | 5579 |
| Tensile | | | | | | | |
| SAT | gsm | 943 | 936 | 1116 | 929 | 980.7 | 948.9 |
| SAT Rate | g/s^{0.5} | 0.592 | 0.503 | 0.727 | 0.550 | 0.5687 | 0.5053 |
| Ply Bond | g/width | 26.2 | 22.6 | 16.6 | 26.4 | 9.9 | 12.9 |
| (Top-Middle) | | | | | | | |
| Ply Bond | g/width | 88.4 | 103.4 | 84.0 | 102.6 | 48.7 | 30.32 |
| (Middle- | | | | | | | |
| Bottom) | | | | | | | |
| Ply Bond | g/width | 114.6 | 126.0 | 100.6 | 129.0 | 58.6 | 43.2 |
| (Total) | | | | | | | |
| Gardner | rubs | — | — | — | 28.1 | 32.6 | 26.1 |

TABLE 5

| | | Comparative Set* | | | |
|---|---|---|---|---|---|
| Property | Unit | C1 | C2 | C3 | C4 |
| Basis Weight | lb/rm | 34.4 | 40.0 | 33.0 | 29.9 |
| Caliper | mils/8 sheet | 280 | 247 | 264 | 191 |
| MD Stretch | % | 11.7 | 49.4 | 22.4 | 29.6 |
| CD Stretch | % | 9.1 | 19.9 | 9.8 | 5.2 |
| CD Wet Tensile | g/3 in | 914 | 496 | 962 | 557 |
| CD Wet TEA | mm-gm/mm² | 0.76 | 0.96 | 0.87 | 0.40 |
| CD Dry Tensile | g/3 in | 2938 | 1318 | 3376 | 2379 |
| MD Dry Tensile | g/3 in | 5122 | 1509 | 3412 | 3446 |
| SAT | gsm | 733 | 723 | 707 | 385 |
| SAT Rate | g/s^{0.5} | 0.300 | 0.263 | 0.405 | 0.133 |
| Ply Bond (Top-Middle) | g/width | — | — | — | |
| Ply Bond (Middle-Bottom) | g/width | — | — | — | |
| Ply Bond (Total) | g/width | 58.0 | N/A | 15.6 | 7.7 |
| Gardner | rubs | 18.4 | 19.9 | 16.0 | 14.5 |

*C1, C3, and C4 are 2-ply paper towel products. C2 is a 1-ply paper product.

1. A three-ply absorbent paper product comprising:
a basis weight of from about 30 lb/rm to about 54 lb/rm,
a caliper of from about 300 mils/8 to about 450 mils/8 sheets,
a SAT capacity of from 800 g/m² to about 1300 g/m², and
a CD wet tensile energy absorption of from about 0.65 ft-lb/ft² to about 1.5 ft-lb/ft².

2. The three-ply absorbent paper product of claim 1, wherein three-ply absorbent paper product has a stretch in the CD direction of from about 6% to about 14%.

3. The three-ply absorbent paper product of claim 1, wherein three-ply absorbent paper product has a stretch in the MD direction of from about 12% to about 30%.

4. The three-ply absorbent paper product of claim 1, wherein the three-ply absorbent paper product has a CD dry tensile strength of from about 3000 g/3 inches to about 7000 g/3 inches.

5. The three-ply absorbent paper product of claim 1, wherein the three-ply absorbent paper product has a MD dry tensile strength of from 3000 g/3 inches to about 8000 g/3 inches.

6. The three-ply absorbent paper product of claim 1, wherein the three-ply absorbent paper product has a CD finch wet tensile strength of from about 1200 g/3 inches to about 2000 g/3 inches.

7. The three-ply absorbent paper product of claim 1, wherein the three-ply absorbent paper product has a CD wet tensile energy absorption of from about 0.85 ft-lb/ft² to about 1.2 ft-lb/ft².

8. The three-ply absorbent paper product of claim 1, wherein the three-ply absorbent paper product has a SAT capacity of from 850 g/m² to about 1100 g/m².

9. The three-ply absorbent paper product of claim 1, wherein the three-ply absorbent paper product has a scrub until fail of from about 24 rubs to about 38 rubs.

10. The three-ply absorbent paper product of claim 1, wherein the three-ply absorbent paper product has a total ply bond of from about 25 g/width to about 170 g/width.

11. The three-ply absorbent paper product of claim 1, wherein the three-ply absorbent paper product has an SAT rate of from about 0.4 g/s^{0.5} to about 0.8 g/s^{0.5}.

12. The three-ply absorbent paper product of claim 1, wherein one ply is a top ply, one ply is a middle ply, and one ply is a bottom ply, and wherein the top ply and middle ply are bonded by adhesive and the middle ply and bottom ply are bonded by adhesive.

13. The three-ply absorbent paper product of claim 1, wherein one ply is a top ply, one ply is a middle ply, and one ply is a bottom ply, and wherein the three-ply absorbent paper product comprises a top-middle ply bond of from about 5 g/width to about 50 g/width.

14. The three-ply absorbent paper product of claim 1, wherein one ply is a top ply, one ply is a middle ply, and one ply is a bottom ply, and wherein the three-ply absorbent paper product has a middle-bottom ply bond of from about 20 g/width to about 120 g/width.

15. The three-ply absorbent paper product of claim 13, wherein only the top ply is embossed and the middle and bottom plies are unembossed.

16. The three-ply absorbent paper product of claim 13, wherein at least two plies are embossed.

17. The three-ply absorbent paper product of claim 13, wherein the top ply and middle ply are embossed and the bottom ply is unembossed.

18. The three-ply absorbent paper product of claim 1, wherein the three-ply absorbent paper product is a paper towel product.

19-56. (canceled)
